(19) United States
(12) Patent Application Publication
(10) Pub. No.: US 2026/0091671 A1
(43) Pub. Date: Apr. 2, 2026

(54) DISPLAY SYSTEM, CONTROL METHOD FOR DISPLAY SYSTEM, ELECTRONIC DEVICE, AND VEHICLE

(71) Applicant: Wuhu Tianma Automotive Electronics Co., Ltd., Wuhu (CN)

(72) Inventors: Zhengyuan HUANG, Wuhu (CN); Weiguo HU, Wuhu (CN); Xiaowei XU, Wuhu (CN)

(73) Assignee: Wuhu Tianma Automotive Electronics Co., Ltd., Wuhu (CN)

(21) Appl. No.: 19/413,274

(22) Filed: Dec. 9, 2025

(30) Foreign Application Priority Data
Jun. 27, 2025 (CN) 202510885025.2

(51) Int. Cl. B60K 35/22; B60K 35/10; G06F 3/041; G06F 3/14

(52) U.S. Cl. CPC B60K 35/22; B60K 35/10; G06F 3/0416; G06F 3/1423; B60K 2360/1438

(57) ABSTRACT

A display system includes at least one signal loading apparatus and at least one display screen. The signal loading apparatus is configured to output a specific signal. The display screen includes a control module, a signal recognition module and a touch module. The control module is electrically connected to the signal recognition module and the touch module. The signal recognition module is configured to receive an input signal and detect whether the input signal includes the specific signal. The control module is configured to control the working state of the touch module according to a detection result of the signal recognition module.

### CROSS-REFERENCE TO RELATED APPLICATIONS

This application claims priority to Chinese Patent Application No. 202510885025.2 filed June 27, 2025, the disclosure of which is incorporated herein by reference in its entirety.

### TECHNICAL FIELD

The present disclosure relates to the field of displays, and in particular, to a display system, a control method for a display system, an electronic device, and a vehicle.

### BACKGROUND

With the improvement of living standards, more and more automobiles have entered families and become daily travel tools.

Based on the development of display technology, the vehicle-mounted display function is integrated into the automobile, and users' requirements for screen usage can be satisfied by a vehicle-mounted display screen.

However, the vehicle-mounted display screen in the automobile may affect driving safety while facilitating the users.

### SUMMARY

The present disclosure provides a display system, a control method for the display system, an electronic device, and a vehicle to improve the driving safety of an automobile.

According to an aspect of the present disclosure, a display system is provided. The display system includes at least one signal loading apparatus and at least one display screen. The at least one signal loading apparatus is configured to output a specific signal. A display screen includes a control module, a signal recognition module and a touch module. The control module is electrically connected to the signal recognition module and the touch module separately. The signal recognition module is configured to receive an input signal and detect whether the specific signal is included in the input signal. The control module is configured to control a working state of the touch module according to a detection result of the signal recognition module.

According to another aspect of the present disclosure, a control method for a display system is provided. The display system includes at least one signal loading apparatus and at least one display screen. The at least one signal loading apparatus is configured to output a specific signal. A display screen includes a control module, a signal recognition module and a touch module which are electrically connected to the control module.

The control method for the at least one display screen includes the following: whether the specific signal is included in an input signal is detected; and a working state of the touch module is controlled according to a detection result.

According to another aspect of the present disclosure, an electronic device is provided. The electronic device includes at least one processor and a memory communicatively connected to the at least one processor. The memory stores a computer program executable by the at least one processor, and the computer program, when executed by the at least one processor, causes the at least one processor to perform the control method for the display system as described above.

According to another aspect of the present disclosure, a vehicle including the display system of the present disclosure is provided.

It is to be understood that the contents described in this section are not intended to identify key or critical features of embodiments of the present disclosure, nor intended to limit the scope of the present disclosure. Other features of the present disclosure will be readily understood from the following Description.

### BRIEF DESCRIPTION OF DRAWINGS

In order to describe technical solutions in embodiments of the present disclosure more clearly, the drawings used for describing the embodiments will be briefly introduced below. Apparently, the drawings in the following description are merely some embodiments of the present disclosure. Other drawings may also be obtained by those of ordinary skill in the art according to these drawings without creative labor.

FIG. 1 is a schematic diagram of a display system according to an embodiment of the present disclosure;

FIG. 2 is a schematic diagram of a vehicle according to an embodiment of the present disclosure;

FIG. 3 is a schematic diagram of another vehicle according to an embodiment of the present disclosure;

FIG. 4 is a schematic diagram of yet another vehicle according to an embodiment of the present disclosure;

FIG. 5 is a schematic diagram of yet another vehicle according to an embodiment of the present disclosure;

FIG. 6 is a schematic diagram of a first display screen according to an embodiment of the present disclosure;

FIG. 7 is a schematic diagram of a second display screen according to an embodiment of the present disclosure;

FIG. 8 is a schematic diagram of yet another vehicle according to an embodiment of the present disclosure;

FIG. 9 is a schematic diagram of another first display screen according to an embodiment of the present disclosure;

FIG. 10 is a schematic diagram of another second display screen according to an embodiment of the present disclosure;

FIG. 11 is a schematic diagram of a signal loading apparatus according to an embodiment of the present disclosure;

FIG. 12 is a schematic diagram of another signal loading apparatus according to an embodiment of the present disclosure;

FIG. 13 is a schematic diagram of a control method for a display system according to an embodiment of the present disclosure; and

FIG. 14 is a schematic diagram of an electronic device according to an embodiment of the present disclosure.

### DETAILED DESCRIPTION

In order that those skilled in the art will better understand the solutions of the present disclosure, the technical solutions adopted, and the technical effects to be achieved by the present disclosure, technical solutions of embodiments of the present disclosure will be clearly and completely described below in conjunction with the accompanying drawings of the embodiments of the present disclosure. Apparently, the described embodiments are merely some embodiments of the present disclosure, rather than all of the embodiments. All other embodiments obtained by those of ordinary skill in the art based on the embodiments of the present disclosure without needing creative efforts shall all fall within the scope of protection of the present disclosure.

It is to be noted that the terms "first", "second" and the like in the Description and claims of the present disclosure, and the foregoing drawings, are used for distinguishing between similar objects and not necessarily for describing a particular order or sequential order. It is to be understood that the data so used are interchangeable as appropriate so that the embodiments of the present disclosure described herein can be implemented in an order other than those illustrated or described herein. Moreover, the terms "include" and "have" as well as any variations thereof, are intended to cover a non-exclusive inclusion, for example, a process, a method, a system, a product, or a device that includes a series of steps or units is not necessarily limited to those steps or units expressly listed, but may include other steps or units not expressly listed or inherent to such process, method, product, or device.

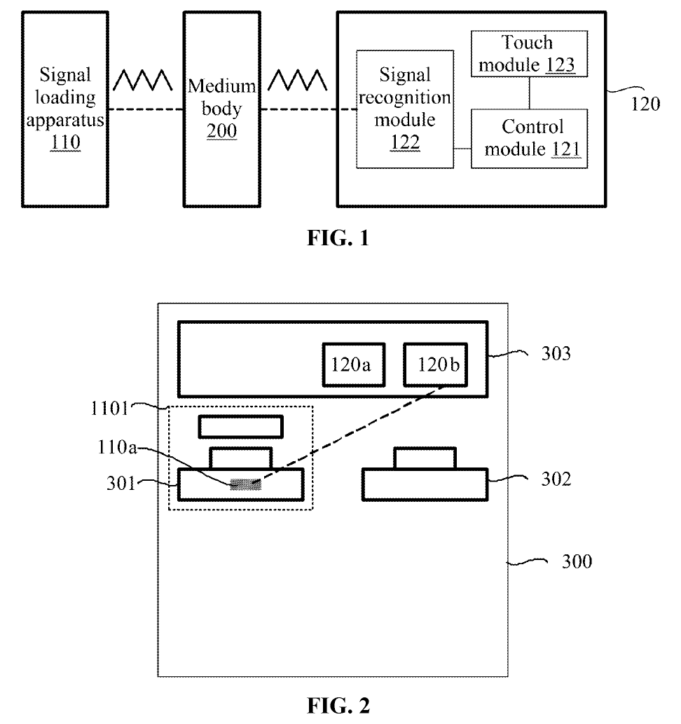

FIG. 1 is a schematic diagram of a display system according to an embodiment of the present disclosure. FIG. 2 is a schematic diagram of a vehicle according to an embodiment of the present disclosure. The vehicle is integrated with the display system shown in FIG. 1. As shown in FIGS. 1 and 2, the display system includes at least one signal loading apparatus 110 and at least one display screen 120. The signal loading apparatus 110 is configured to output a specific signal. A display screen 120 includes a control module 121, a signal recognition module 122 and a touch module 123. The control module 121 is electrically connected to the signal recognition module 122 and the touch module 123. The signal recognition module 122 is configured to receive an input signal and detect whether the input signal includes the specific signal. The control module 121 is configured to control a working state of the touch module 123 according to a detection result of the signal recognition module 122.

In this embodiment, the display system includes a signal loading apparatus 110, and the signal loading apparatus 110 may generate the specific signal and output the specific signal through a medium body 200. The medium body 200 may be in contact with the signal loading apparatus 110 to achieve signal transmission. The specific signal generated by the signal loading apparatus 110 is output through the medium body 200 contacting with the signal loading apparatus 110; for example, the medium body is a human body. Alternatively, the medium body 200 and the signal loading apparatus 110 may achieve signal transmission in a wired or wireless manner, and the medium body 200 receives the specific signal provided by the signal loading apparatus 110 and then outputs the specific signal; for example, the medium body is a stylus. The display system may include multiple signal loading apparatuses 110. The multiple signal loading apparatuses 110 operate independently of each other, and specific signals generated by any two signal loading apparatuses 110 are different based on product requirements.

The signal loading apparatus 110 is configured to output the specific signal, and the signal loading apparatus 110 includes components and structures related to the generation of the specific signal. Depending on differences in the generated specific signals, circuit structures of the signal loading apparatuses 110 are also different, which is not limited herein. In FIG. 1, the waveform of the specific signal output by the signal loading apparatus 110 is a triangular wave.

In one or more embodiments, the specific signal includes a signal having a specific frequency and/or a specific waveform.

For two different signal loading apparatuses in the display system, in one or more embodiments, the frequency of the specific signal output by one signal loading apparatus is different from the frequency of the specific signal output by the other signal loading apparatus. Exemplarily, the specific signal output by one signal loading apparatus is a triangular wave of 120 Hz, and the specific signal output by the other signal loading apparatus is a triangular wave of 60 Hz.

Alternatively, for two different signal loading apparatuses in the display system, in one or more embodiments, the waveform of the specific signal output by one signal loading apparatus is different from the waveform of the specific signal output by the other signal loading apparatus. Exemplarily, the specific signal output by one signal loading apparatus is a triangular wave, and the specific signal output by the other signal loading apparatus is a square wave.

Alternatively, for two different signal loading apparatuses in the display system, in one or more embodiments, both the frequency and the waveform of the specific signal output by one signal loading apparatus are different from the frequency and the waveform of the specific signal output by the other signal loading apparatus. Exemplarily, the specific signal output by one signal loading apparatus is a triangular wave of 120 Hz, and the specific signal output by the other signal loading apparatus is a square wave of 60 Hz.

It is to be understood that the differences between the specific signals output by the two different signal loading apparatuses include, but are not limited to, the frequency and waveform.

The display system includes a display screen 120, and a signal acquired by the display screen 120 through the medium body 200 is a received input signal. The medium body 200 may be in contact with the display screen 120 to achieve signal transmission, and the display screen 120 acquires the input signal through the medium body 200 contacting with the display screen 120. Alternatively, the medium body 200 and the display screen 120 may achieve signal transmission in a wired or wireless manner, and the display screen 120 obtains the input signal through the medium body 200. The display system may include multiple display screens 120, and the multiple display screens 120 operate independently of each other.

The display system shown in FIG. 1 includes one signal loading apparatus 110 and one display screen 120. The medium body 200 may communicate with the signal loading apparatus 110 and the display screen 120 so that the specific signal generated by the signal loading apparatus 110 is transmitted to the display screen 120 via the medium body 200. When the display system includes multiple signal loading apparatuses 110 and multiple display screens 120, a corresponding specific signal may be transmitted between one signal loading apparatus 110 and one display screen 120 that communicates via one medium body 200; specifically, the specific signal generated by the signal loading apparatus 110 is transmitted to the display screen 120 via the medium body 200.

The display screen 120 includes the control module 121, the signal recognition module 122 and the touch module 123. The control module 121 is electrically connected to the signal recognition module 122 and the touch module 123. The display screen 120 is configured to receive the input signal through the medium body 200. The signal recognition module 122 may detect the input signal. Specifically, the specific signal generated by the signal loading apparatus 110 is transmitted to the display screen 120 via the medium body 200, the signal recognition module 122 is configured to detect whether the input signal includes the specific signal, and the control module 121 is configured to control the working state of the touch module 123 according to the detection result of the signal recognition module 122. Here, the working state of the touch module 123 includes at least an on state of the touch module 123 or an off state of the touch module 123. Specifically, one signal loading apparatus 110 communicates with one display screen 120 via one medium body 200, and the specific signal generated by this signal loading apparatus 110 is transmitted to the display screen 120 via the medium body 200. When the signal recognition module 122 of the display screen 120 recognizes the specific signal of the signal loading apparatus 110, the display screen 120 controls the touch module 123 to be turned on or off.

In the display screen 120, the control module 121 includes related components, chips, structures, and the like that perform corresponding functions, the signal recognition module 122 includes related components and structures that perform signal recognition functions and signal detection functions, and the touch module 123 includes related components and structures that perform the touch function. In the present disclosure, the structure of each module is not specifically limited, and the structure of each module in the display screen may be adaptively adjusted and changed based on the requirements of functional use and the like of the display screen. The touch module is used as an example, if the display screen has a capacitive touch function, the touch module includes at least related circuit structures, such as a capacitive touch layer, and the corresponding medium body may be a human body or a capacitive pen. Alternatively, if the display screen has an electromagnetic touch function, the touch module includes at least related circuit structures such as an electromagnetic touch layer, and the corresponding medium body may be an electromagnetic pen.

When the display system includes multiple signal loading apparatuses 110, specific signals provided by two different signal loading apparatuses 110 are different, and thus, control operations of the same display screen 120 for different specific signals may be different. Exemplarily, the display system includes a first signal loading apparatus providing a first specific signal and a second signal loading apparatus providing a second specific signal. The first specific signal generated by the first signal loading apparatus is transmitted to the display screen 120 via the medium body. When the display screen 120 detects that the input signal includes the first specific signal, the touch module 123 is controlled to be turned on so that the display screen 120 activates the touch function. Alternatively, the second specific signal generated by the second signal loading apparatus is transmitted to the same display screen 120 via the medium body. When the display screen 120 detects that the input signal includes the second specific signal, the touch module 123 is controlled to be turned off so that the display screen 120 deactivates the touch function.

When the display system includes multiple display screens 120, control operations of two different display screens 120 for the same specific signal may be different. Exemplarily, the display system includes a first signal loading apparatus providing a first specific signal, the first specific signal generated by the first signal loading apparatus is transmitted to a first display screen 120 via the medium body, and when the first display screen 120a detects that the input signal includes the first specific signal, the touch module 123 in this screen is turned on. Alternatively, the first specific signal generated by the first signal loading apparatus is transmitted to a second display screen 120b via the medium body, and when the second display screen 120b detects that the input signal includes the first specific signal, the touch module 123 in this screen is turned off.

Exemplarily, the vehicle 300 shown in FIG. 2 may be an automobile, but is not limited thereto. In FIG. 2, the automobile 300 includes a driver seat 301, a passenger seat 302 and a main console 303. The signal loading apparatus 110 includes a signal loading module 110a. The signal loading module 110a is configured to generate a specific signal and is integrated in the driver seat 301, and the specific signal generated by the signal loading module 110a may be transmitted to the driver seat 301. A first display screen 120a and a second display screen 120b are integrated on the main console 303, and the distance between the second display screen 120b and the signal loading module 110a is relatively large. In one or more embodiments, the passenger on the seat is the medium body. If the passenger sits on the seat, the specific signal generated by the signal loading module 110a in the seat may be transmitted to the display screen via the passenger. When the driver manually touches a distant display screen while driving, great safety hazards occur, that is, distraction and a tendency to lean the driver's body may cause the steering wheel to deviate.

Based on the preceding, in this embodiment, the specific signal provided by the signal loading module 110a in the driver seat 301 is output through the driver (i.e., the medium body) on the driver seat 301. In one or more embodiments, the signal loading module 110a provides a triangular wave of 120 Hz. If the driver touches the second display screen 120b, the triangular wave of 120 Hz provided by the signal loading module 110a is transmitted to the second display screen 120b via the driver, and the second display screen 120b detects the input signal. When the signal recognition module of the second display screen 120b recognizes the triangular wave of 120 Hz, the second display screen 120b controls the touch module in the second display screen 120b to be turned off, and the touch function of the second display screen 120b is turned off; in this manner, the distant second display screen 120b cannot be touched by the driver, thereby enhancing the driving safety of the vehicle. In addition, other people except the driver may touch the first display screen 120a and the second display screen 120b to satisfy users' requirements for screen usage.

The display system provided in the present disclosure includes the at least one signal loading apparatus and the at least one display screen. The at least one signal loading apparatus is configured to output the specific signal. The at least one display screen includes the control module, the signal recognition module and the touch module. The control module is electrically connected to the signal recognition module and the touch module. The signal recognition module is configured to receive the input signal and detect whether the input signal includes the specific signal. The control module is configured to control the working state of the touch module according to the detection result of the signal recognition module. The display system of the present disclosure includes the at least one signal loading apparatus and the at least one display screen. The medium body may communicate the signal loading apparatus with the display screen so that the specific signal generated by the signal loading apparatus is transmitted to the display screen via the medium body. The signal loading apparatus is configured to output the specific signal. In the display screen, the signal recognition module is configured to receive the input signal and detect whether the input signal includes the specific signal, and the control module is configured to control the working state of the touch module according to the detection result of the signal recognition module. The display system provided in the present disclosure enables the display screen to control the touch module in the display screen to be turned off when detecting that the input signal includes the specific signal, so that the display screen cannot be touched, thereby avoiding problems such as body inclination and distraction caused by the driver touching the display screen with his hand during the high-speed driving, reducing the safety risk of deviation of the steering wheel, and facilitating the improvement on the driving safety of the vehicle.

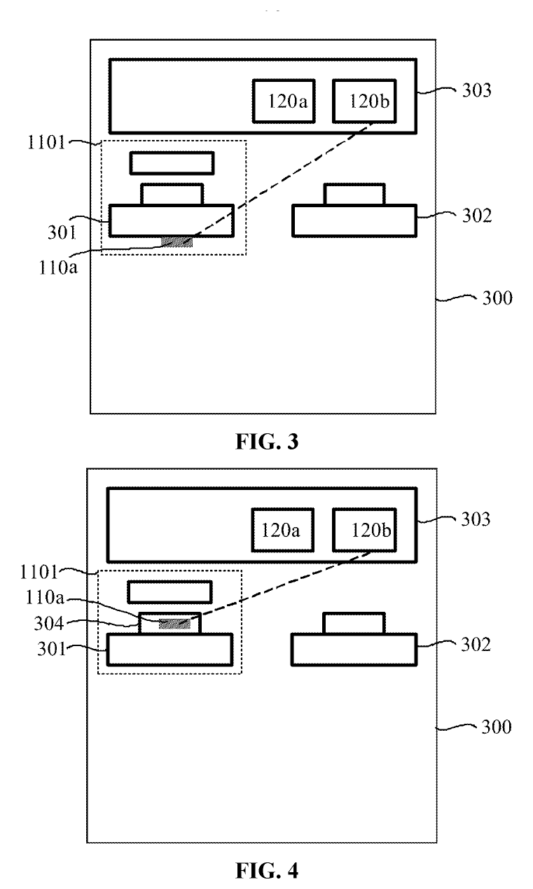

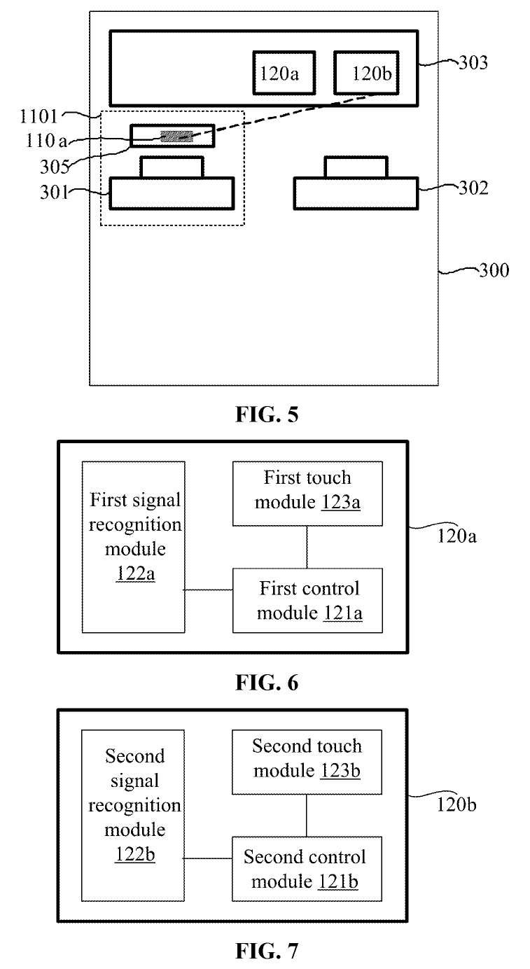

FIG. 3 is a schematic diagram of another vehicle according to an embodiment of the present disclosure. FIG. 4 is a schematic diagram of another vehicle according to an embodiment of the present disclosure. FIG. 5 is a schematic diagram of another vehicle according to an embodiment of the present disclosure. FIG. 6 is a schematic diagram of a first display screen according to an embodiment of the present disclosure. FIG. 7 is a schematic diagram of a second display screen according to an embodiment of the present disclosure. As shown in FIGS. 2 to 7, the vehicle 300 is integrated with the display system shown in FIG. 1. In one or more embodiments, the vehicle 300 is an automobile, but is not limited thereto. In one or more embodiments, at least one signal loading apparatus 110 includes a first signal loading apparatus 1101. The specific signal includes a first specific signal output by the first signal loading apparatus 1101. At least one display screen 120 includes a first display screen 120a and a second display screen 120b. The first display screen 120a includes a first control module 121a, a first signal recognition module 122a and a first touch module 123a, and the second display screen 120b includes a second control module 121b, a second signal recognition module 122b and a second touch module 123b. In the second display screen 120b, the second signal recognition module 122b is configured to, when detecting that the input signal includes the first specific signal, output a touch turn-off signal to enable the second control module 121b to control the second touch module 123b to be turned off.

In one or more embodiments, the first signal loading apparatus 1101 includes a first seat 301, a first seat belt 304, a steering wheel 305, and a first signal loading module 110a configured to output a first specific signal. The first signal loading module 110a is mounted on at least one of the first seat 301, the first seat belt 304, and the steering wheel 305. As shown in FIG. 2, the first signal loading module 110a is mounted inside the first seat 301. As shown in FIG. 3, the first signal loading module 110a is mounted on a side of the first seat 301 facing away from the main console 303. As shown in FIG. 4, the first signal loading module 110a is mounted inside the first seat belt 304. As shown in FIG. 5, the first signal loading module 110a is mounted inside the steering wheel 305. However, it is not limited thereto, the mounting position of the first signal loading module may further include at least one of the following: 1) the first signal loading module is mounted at the bottom of the first seat; 2) the first signal loading module is mounted in the foot pedal region of the occupant of the first seat; and 3) the first signal loading module is mounted on the rear seat, and the first specific signal generated by the first signal loading module is transmitted to the first seat via the rear passenger, and then is transmitted to the display screen via the occupant of the first seat. In the present disclosure, the mounting position of the first signal loading module is not limited as long as it is ensured that the first specific signal generated by the first signal loading module may be transmitted to one or more display screens via one or more medium bodies.

In this embodiment, the first seat 301 and the first seat belt 304 may be the driver seat 301 and the driver belt 304 of the automobile 300. In a case where the display system of the automobile includes multiple screens, the distance between the second display screen 120b and the first signal loading apparatus 1101 may be large, and when the driver manually touches the distant second display screen 120b while driving, the driver may lean his body or be distracted to cause the steering wheel to deviate, which poses great safety hazards.

Based on above, the first signal loading module 110a of the first signal loading apparatus 1101 is configured to output the first specific signal, and when the first specific signal of the first signal loading apparatus 1101 is transmitted to the second display screen 120b via the medium body, the second display screen 120b is designed to turn off the touch function so that the distant second display screen 120b cannot be touched by the driver, which is conducive to improving the driving safety of the vehicle.

Specifically, the first specific signal of the first signal loading apparatus 1101 is transmitted to the second display screen 120b via the medium body, the second signal recognition module 122b in the second display screen 120b is configured to receive and detect the input signal and is configured to, when detecting that the input signal includes the first specific signal, output a touch turn-off signal so that the second control module 121b controls the second touch module 123b to be turned off according to the touch turn-off signal; in this manner. the second display screen 120b deactivates the touch function for the driver. Conversely, the first specific signal of the first signal loading apparatus 1101 is transmitted to the second display screen 120b via the medium body, the second signal recognition module 122b is configured to output a touch turn-on signal when detecting that the input signal does not include the first specific signal, and the second control module 121b controls the second touch module to be kept in the on state according to the touch turn-on signal. Therefore, the second display screen 120b deactivates the touch function only for the driver, whereby the display and touch requirements of front passenger, rear passengers, and the like are ensured.

Further, in one or more embodiments, the first signal loading apparatus 1101 includes multiple first signal loading modules 110a. The multiple first signal loading modules 110a output the same first specific signal and may be mounted at different positions. In this embodiment, multiple same specific signals output by the multiple first signal loading modules 110a may be synchronously transmitted to the same display screen via the same medium body. When an ineffective first signal loading module 110a exists in the first signal loading apparatus 1101, other effective first signal loading modules 110a in the first signal loading apparatus 1101 may ensure that the first specific signal is transmitted to the display screen via the medium body, thereby improving the reliability and stability of signal transmission of the first signal loading apparatus 1101, and thus improving the driving safety.

In one or more embodiments, in the first display screen 120a, the first control module 121a is configured to control the first touch module 123a to be in an on state. In this embodiment, in a case where the display system of the automobile includes multiple screens, since the distance between the first display screen 120a and the first signal loading apparatus 1101 is moderate, no human body tilt may occur when the driver manually touches the first display screen 120a. Therefore, the first display screen 120a is designed to keep the touch function in the on state, thereby enabling the driver and passengers to use the first display screen 120a normally and satisfying the display and touch requirements of passengers.

In one or more embodiments, the display system includes an acquisition module electrically connected to the first signal loading apparatus. The acquisition module is configured to: acquire first working information of a device electrically connected to the display system; control the first signal loading apparatus to be turned on when detecting that the first working information satisfies a preset turn-on condition; and control the first signal loading apparatus to be turned off when detecting that the first working information does not satisfy the preset turn-on condition.

In this embodiment, the automobile includes a vehicle controller. Herein, the first working information may include a vehicle speed of the automobile, and the preset turn-on condition may include the vehicle speed exceeding a vehicle speed safety threshold. The display system integrated in the automobile may be electrically connected to the vehicle controller, and the acquisition module of the display system may acquire information such as the vehicle speed of the automobile through the vehicle controller. In one or more embodiments, the vehicle speed safety threshold ranges from 40 km/h to 60 km/h; for example, the vehicle speed safety threshold is 50 km/h.

If the acquisition module determines that the vehicle speed of the automobile does not exceed the vehicle speed safety threshold, that is, the first working information does not satisfy the preset turn-on condition, the behavior of the driver touching the display screen at this time is within the safe controllable range, the first signal loading module is controlled to be turned off, and the touch function of the display screen in the display system is normally activated without being affected by the specific signal output by the signal loading apparatus.

If the acquisition module determines that the vehicle speed of the automobile exceeds the vehicle speed safety threshold, that is, the first working information satisfies the preset turn-on condition, the vehicle speed is too fast at this time, and the behavior of the driver touching the display screen is dangerous. In this case, the first signal loading module is turned on to output the first specific signal, and when the second display screen in the display system detects the first specific signal, the touch control function is turned off so that the second display screen cannot be touched by the driver, which is conducive to improving driving safety.

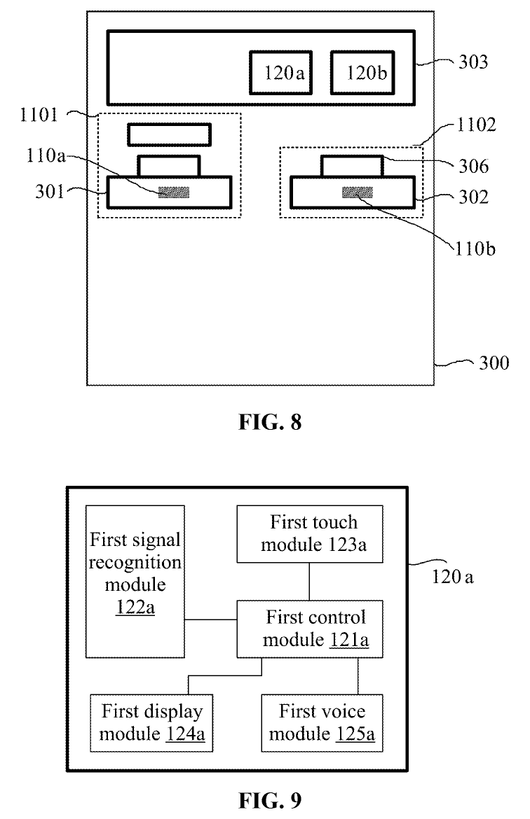

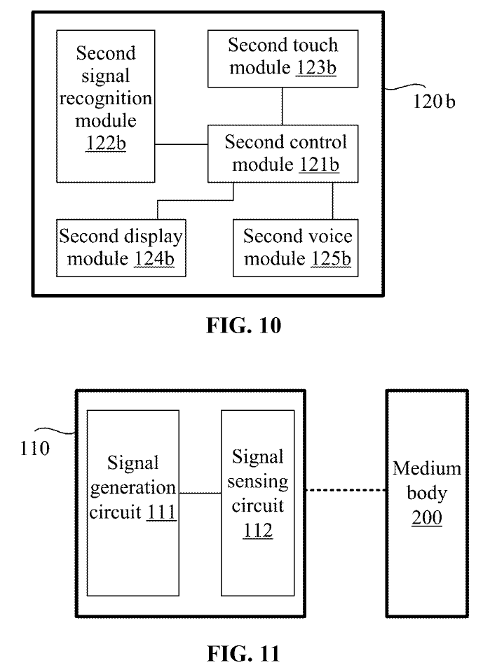

FIG. 8 is a schematic diagram of another vehicle according to an embodiment of the present disclosure. FIG. 9 is a schematic diagram of another first display screen according to an embodiment of the present disclosure. FIG. 10 is a schematic diagram of another second display screen according to an embodiment of the present disclosure. Referring to FIGS. 2 to 10, the vehicle 300 is integrated with the display system shown in FIG. 1, the vehicle 300 is an automobile. In one or more embodiments, the at least one signal loading apparatus 110 includes a first signal loading apparatus 1101, the specific signal includes a first specific signal output by the first signal loading apparatus 1101, and the first signal loading apparatus 1101 includes a first signal loading module 110a configured to output the first specific signal. In one or more embodiments, the frequency of the second specific signal is different from the frequency of the first specific signal, and/or, the waveform of the second specific signal is different from the waveform of the first specific signal.

In one or more embodiments, the at least one signal loading apparatus 110 includes a second signal loading apparatus 1102. The specific signal includes the second specific signal output by the second signal loading apparatus 1102, and the second specific signal is different from the first specific signal. In one or more embodiments, the second signal loading apparatus 1102 includes a second seat 302, a second seat belt 306, and the second signal loading module 110b configured to output the second specific signal, and the second signal loading module 110b is mounted in the second seat 302 and/or the second seat belt 306. As shown in FIG. 8, the second signal loading module 110b is mounted inside the second seat 302.

In other embodiments, the mounting position of the second signal loading module includes at least one of the following: 1) the second signal loading module is mounted on the side of the second seat facing away from the main console; 2) the second signal loading module is mounted inside the second seat belt; 3) the second signal loading module is mounted at the bottom of the second seat; 4) the second signal loading module is mounted in the foot pedal region of the occupant of the second seat; and 5) the second signal loading module is mounted on the rear seat. In a case where the second specific signal generated by the second signal loading module may be ensured to be transmitted to one or more display screens via one or more medium bodies, the mounting position of the second signal loading module is not restricted. Further, in one or more embodiments, the second signal loading apparatus includes multiple second signal loading modules, and the multiple second signal loading modules output the same second specific signal and may be mounted at different positions. Therefore, when an ineffective second signal loading module occurs, the effective second signal loading module may transmit the second specific signal to the display screen via the medium body.

In one or more embodiments, the display screen includes a display module and a voice module. The control module is electrically connected to the display module and the voice module and is configured to control at least one of the display module or the voice module to output a safety reminder signal when the touch module is controlled to be turned off. The first display screen 120a includes a first display module 124a and a first voice module 125a. The second display screen 120b includes a second display module 124b and a second voice module 125b.

In this embodiment, the second seat 302 and the second seat belt 306 may be a front passenger seat and a front passenger seat belt of the automobile 300.

For the vehicle shown in FIG. 8, the second display screen 120b of the embodiments of the present disclosure may include at least one of the following control modes.

A first control mode of the second display screen 120b is as follows: The second signal recognition module 122b is configured to output a touch turn-off signal when detecting that the input signal includes the first specific signal, so the second control module 121b is enabled to control the second touch module 123b to be turned off, and the second display screen 120b deactivates the touch function for the driver. The second signal recognition module 122b is configured to output a touch turn-on signal when detecting that the input signal does not include the first specific signal, so the second control module 121b controls the second touch module 123b to be kept in the on state according to the touch turn-on signal. Therefore, the driver cannot touch the distant second display screen 120b, while other users may normally touch the second display screen 120b, which is conducive to improving the driving safety of the vehicle. When the second display screen 120b deactivates the touch function, at least one of the second display module 124b and the second voice module 125b outputs the safety reminder signal, and the safety reminder signal includes the contents for reminding the driver to drive safely and may alert the driver to concentrate on driving.

A second control mode of the second display screen 120b is as follows: in one or more embodiments, the second signal recognition module 122b is configured to output a touch turn-on signal when detecting that the input signal includes the second specific signal, so the second control module 121b is enabled to control the second touch module 123b to be turned on. Specifically, when detecting that the input signal includes the first specific signal, the second signal recognition module 122b is configured to output the touch turn-off signal to enable the second display screen 120b to turn off the touch function for the driver. The second signal recognition module 122b is configured to output a touch turn-on signal when detecting that the input signal includes the second specific signal, the second control module 121b controls the second touch module 123b to be turned on according to the touch turn-on signal, so the second display screen 120b activates the touch function for a medium body (such as the front passenger) communicating with the second signal loading apparatus 1102. Therefore, the distant second display screen 120b cannot be touched by the driver, and only the medium body communicating with the second signal loading apparatus 1102 may normally touch the second display screen 120b, thereby preventing a third person such as a child from accidentally touching the second display screen 120b, and improving the driving safety of the vehicle. Here, when the second display screen 120b deactivates the touch function, at least one of the second display module 124b and the second voice module 125b outputs the safety reminder signal, and the safety reminder signal includes the content for reminding the third person not to touch the display screen and the like, reducing interference to the driver.

For the vehicle shown in FIG. 8, the first display screen 120a of the embodiments of the present disclosure may include at least one of the following control modes.

A first control mode of the first display screen 120a is as follows: The first signal recognition module 122a is configured to detect whether the input signal exists, and when the first signal recognition module 122a detects the input signal, the first control module 121a is configured to control the first touch module 123a to be kept in the on state. Therefore, the users, such as the driver and passengers, may normally touch the first display screen 120a to satisfy the normal display requirements of passengers.

A second control mode of the first display screen 120a is as follows: in one or more embodiments, when detecting that the input signal includes the first specific signal or the second specific signal, the first signal recognition module 122a is configured to output the touch turn-on signal so that the first control module 121a controls the first touch module 123a to be turned on. Specifically, the first signal recognition module 122a is configured to output the touch turn-on signal when detecting that the input signal includes the first specific signal, or the first signal recognition module 122a is configured to output the touch turn-on signal when detecting that the input signal includes the second specific signal so that the first display screen 120a turns on the touch function only for the driver and the front passenger. The first signal recognition module 122a is configured to output the touch turn-off signal when detecting that the input signal does not include the first specific signal and the second specific signal, so the first display screen 120a turns off the touch function for the third person other than the first signal loading apparatus 1101 and the second signal loading apparatus 1102, thereby preventing accidental touches on the first display screen 120a by the third person such as children and improving the driving safety of the vehicle. Here, when the first display screen 120a turns off the touch function, at least one of the first display module 124a and the first voice module 125a outputs the safety reminder signal, and the safety reminder signal includes the content for reminding the third person not to touch the display screen and the like, reducing interference to the driver.

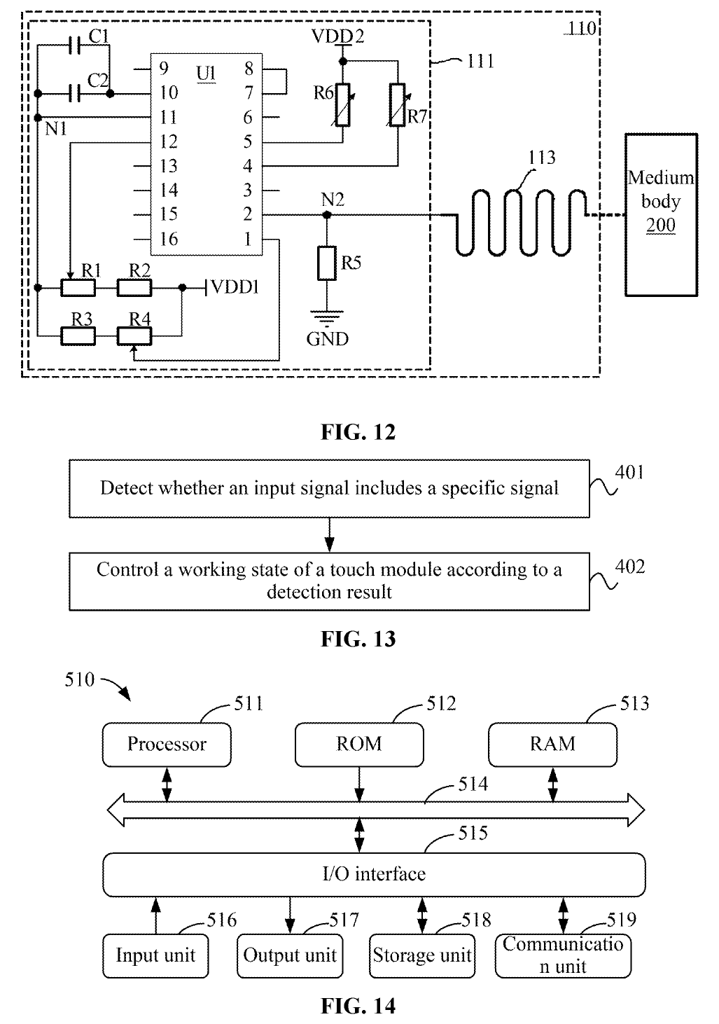

FIG. 11 is a schematic diagram of a signal loading apparatus according to an embodiment of the present disclosure. FIG. 12 is a schematic diagram of another signal loading apparatus according to an embodiment of the present disclosure. As shown in FIGS. 11 and 12, in one or more embodiments, the signal loading apparatus 110 includes a signal generation circuit 111 and a signal sensing circuit 112 electrically connected to each other. The signal generation circuit 111 is configured to generate the specific signal. The signal sensing circuit 112 is configured to transmit the specific signal to the medium body 200. The signal generation circuit of the first signal loading apparatus is configured to generate the first specific signal, and the signal generation circuit of the second signal loading apparatus is configured to generate the second specific signal. In one or more embodiments, the signal sensing circuit 112 includes signal conduction lines that are distributed in an extended manner, and the signal generation circuit 111 includes a precision oscillation integrated circuit outputting multiple waveforms.

The signal generation circuit 111 is the precision oscillation integrated circuit having multiple outputted waveforms. Specifically, the signal generation circuit 111 may include at least a microcontroller U1, a first capacitor C1, a second capacitor C2, and a first resistor R1 to a seventh resistor R7. The first capacitor C1 and the second capacitor C2 are connected in parallel, the first capacitor C1 is electrically connected between a node N1 and pin 10 of the microcontroller U1, and the second capacitor C2 is electrically connected between the node N1 and pin 10 of the microcontroller U1. The node N1 is electrically connected to pin 11 of the microcontroller U1.

The first resistor R1 is a sliding rheostat. A first terminal of the first resistor R1 is electrically connected to the node N1, a second terminal of the first resistor R1 is electrically connected to a first power supply terminal VDD1 via the second resistor R2, and the sliding contact terminal of the first resistor R1 is electrically connected to pin 12 of the microcontroller U1.

The fourth resistor R4 is a sliding rheostat, a first terminal of the fourth resistor R4 is electrically connected to the first power supply terminal VDD1, a second terminal of the fourth resistor R4 is electrically connected to the node N1 via the third resistor R3, and the sliding contact terminal of the fourth resistor R4 is electrically connected to pin 1 of the microcontroller U1.

The sixth resistor R6 and the seventh resistor R7 are each an adjustable resistor, the sixth resistor R6 is electrically connected between the second power supply terminal VDD2 and pin 5 of the microcontroller U1, and the seventh resistor R7 is electrically connected between the second power supply terminal VDD2 and pin 4 of the microcontroller U1.

The fifth resistor R5 is electrically connected between a node N2 and a ground terminal GND. The signal conduction line 113 is electrically connected to the node N2. If the desired specific signal is a triangular wave, the node N2 is electrically connected to pin 2 of the microcontroller U1, as shown in FIG. 12. In other embodiments, if the desired specific signal is a sine wave, the node N2 is electrically connected to pin 3 of the microcontroller U1. In other embodiments, if the desired specific signal is a square wave, the node N2 is electrically connected to pin 9 of the microcontroller U1.

Each of the first specific signal and the second specific signal having the triangular wave is used as an example. Referring to FIG. 12, the signal generation circuit 111 may generate at least triangular waves of various frequencies in a range of 30 Hz to 150 Hz by adjusting the resistance value of the sixth resistor R6 and/or the resistance value of the seventh resistor R7, and the generated triangular wave of a specific frequency is output to the signal conduction line 113 through pin 2 of the microcontroller U1. Exemplarily, the signal generation circuit of the first signal loading apparatus may output a triangular wave of 120 Hz by adjusting the resistance value of the sixth resistor R6 and/or the resistance value of the seventh resistor R7. The signal generation circuit of the second signal loading apparatus may output a triangular wave of 30 Hz by adjusting the resistance value of the sixth resistor R6 and/or the resistance value of the seventh resistor R7.

When the signal conduction line 113 of the signal loading apparatus 110 communicates with the medium body 200, the triangular wave of the specific frequency generated by the signal loading apparatus 110 is transmitted to the medium body 200 through the signal conduction line 113. When the medium body 200 communicates with the signal loading apparatus 110 and the display screen, the triangular wave of the specific frequency generated by the signal loading apparatus 110 is transmitted to the display screen via the medium body 200. The display screen is configured to: perform signal recognition and detection, control the working state of the touch module therein based on a detection result, and control the touch function to be turned on or off based on the detection result.

It is to be noted that the specific signal generated by the signal loading apparatus 110 is an electrical signal harmless to the human body, and electrical parameters of the electrical signal, such as voltage, current, and frequency, are all within the safe range acceptable to the human body. When the medium body 200 is a human body, the specific signal generated by the signal loading apparatus 110 is transmitted to the display screen via the human body, which does not cause damage to the human body and ensures the safety of the users.

In the present disclosure, the capacitors, resistors, power supply, microcontroller, and the like of the signal loading apparatus in FIG. 12 are not limited, and the circuit of the signal loading apparatus may be reasonably designed by relevant practitioners according to product requirements.

In this embodiment, the signal loading apparatus is added to the display system, the signal recognition module is added to the display screen, and the display screen uses the signal recognition module to recognize whether the input signal transmitted by the medium body contains the specific signal. For example, the second display screen uses the signal recognition module to recognize whether the input signal includes the first specific signal, to determine if the driver touches the second display screen, and the second display screen turns off the touch function for the driver, which improves the driving safety and reduces the safety hazards.

Based on the same inventive concept, an embodiment of the present disclosure further provides a control method for a display system. This embodiment may be applied to the display system described in any of the above embodiments. The display system includes at least one signal loading apparatus and at least one display screen. The at least one signal loading apparatus is configured to output a specific signal, and a display screen includes a control module, a signal recognition module and a touch module which are electrically connected to the control module.

An embodiment of the present disclosure further provides a vehicle including the display system described in any of the above embodiments. Vehicles are an indispensable part of modern people's lives. With the changes of the times and the advancement of science and technology, there are more and more vehicles around people, which brings great convenience to everyone's life. Cars on land, ships in the ocean, planes in the sky, elevators that transport people vertically in the buildings, and the like are all vehicles. To improve the convenience of use, one or more display screens are integrated into a vehicle. Based on this, in a case where the display requirements of the users are satisfied, it is also necessary to enhance the safety of vehicles. In the present disclosure, the display system may control the touch function of the display screen to be turned on or off based on the specific signal, thereby reducing the safety hazards.

The control method provided in this embodiment may be performed by a control apparatus, and the control apparatus may be implemented in the form of hardware and/or software and may be configured in the display screen. For example, the first display screen includes a first control apparatus, and the second display screen includes a second control apparatus.

FIG. 13 is a schematic diagram of a control method for a display system according to an embodiment of the present disclosure. As shown in FIG. 13, the control method for the display screen in the display system includes steps described below.

In step 401, whether an input signal includes a specific signal is detected.

In step 402, a working state of a touch module is controlled according to a detection result.

In one or more embodiments, at least one signal loading apparatus includes a first signal loading apparatus, the specific signal includes a first specific signal output by the first signal loading apparatus, and at least one display screen includes a first display screen and a second display screen. A control method for the second display screen includes that the touch module of the second display screen is controlled to be turned off when it is detected that the input signal includes the first specific signal.

In one or more embodiments, at least one signal loading apparatus includes a second signal loading apparatus, the specific signal includes a second specific signal output by the second signal loading apparatus, and the second specific signal is different from the first specific signal. The control method for the second display screen further includes that the touch module of the second display screen is controlled to be turned on when it is detected that the input signal includes the second specific signal.

The first control apparatus in the first display screen provided in the embodiments of the present disclosure may perform the control method for the first display screen provided in any of the embodiments of the present disclosure, and the second control apparatus in the second display screen may perform the control method for the second display screen provided in any of the embodiments of the present disclosure, and has corresponding functional modules and beneficial effects for performing the method.

In the present disclosure, the display system includes at least one signal loading apparatus and at least one display screen. The medium body communicates with the signal loading apparatus and the display screen so that the specific signal generated by the signal loading apparatus is transmitted to the display screen via the medium body. The signal loading apparatus is configured to output the specific signal. In the display screen, the signal recognition module is configured to receive the input signal and detect whether the input signal includes the specific signal. The control module is configured to control the working state of the touch module according to the detection result of the signal recognition module. The vehicle being the automobile is used as an example. Currently, significant safety hazards exist when the driver manually touches the distant display screen while driving. In the present disclosure, when the driver manually touches a distant display screen when driving, the display system of the vehicle may be designed as follows: the touch module in the screen is controlled to be turned off when the display screen far from the driver seat detects that the input signal includes the specific signal input by the driver in the driver seat so that the instant display screen cannot be touched by the driver of the vehicle, thereby avoiding problems such as body inclination and distraction caused by the driver touching the display screen with his hand during the high-speed driving, reducing the safety risk of deviation of the steering wheel, and being beneficial to improving the driving safety of the vehicle.

Based on the same inventive concept, an embodiment of the present disclosure further provides an electronic device. The electronic device includes at least one processor and a memory communicatively connected to the at least one processor. The memory stores a computer program executable by the at least one processor, and the computer program, when executed by the at least one processor, causes the at least one processor to perform the control method for the display system described in any of the above embodiments.

FIG. 14 is a schematic diagram of an electronic device according to an embodiment of the present disclosure. As shown in FIG. 14, the electronic device 510 is intended to represent various forms of digital computers, such as laptops, desktops, workstations, personal digital assistants, servers, blade servers, mainframe computers, and other appropriate computers. The electronic device 510 may also represent various forms of mobile devices, such as personal digital assistants, cellphones, smartphones, wearable devices (such as helmets, glasses, and watches), and other similar computing devices. The components shown herein, their connections and relationships between these components, and the functions of these components are illustrative merely and are not intended to limit implementations of the present disclosure described and/or claimed herein.

The electronic device 510 includes at least one processor 511 and a memory communicatively connected to the at least one processor 511, such as a read-only memory (ROM) 512 and a random access memory (RAM) 513. The memory stores a computer program executable by the at least one processor 511, and the computer program, when executed by the at least one processor 511, causes the at least one processor 511 to perform the method described in any one of the embodiments of the present disclosure. The processor 511 may execute various appropriate actions and processes based on a computer program stored in the ROM 512 or a computer program loaded from a storage unit 518 into the RAM 513. Various programs and data required for the operation of the electronic device 510 may also be stored in the RAM 513. The processor 511, the ROM 512, and the RAM 513 are connected to each other via a bus 514. An input/output (I/O) interface 515 is also connected to the bus 514.

Multiple components in the electronic device 510 are connected to the I/O interface 515, and the multiple components include an input unit 516 such as a keyboard or a mouse, an output unit 517 such as various types of displays or speakers, the storage unit 518 such as a magnetic disk or an optical disk, and a communication unit 519 such as a network card, a modem or a wireless communication transceiver. The communication unit 519 allows the electronic device 510 to exchange information/data with other devices over a computer network, such as the Internet and/or various telecommunication networks.

The processor 511 may be a variety of general-purpose and/or dedicated processing assemblies having processing and computing capabilities. Some examples of the processor 511 include, but are not limited to, a central processing unit (CPU), a graphics processing unit (GPU), a special-purpose artificial intelligence (AI) computing chip, a processor executing machine learning model algorithms, a digital signal processor (DSP), and any suitable processor, controller and microcontroller. The processor 511 performs the various methods and processes described above, such as the method described in any one of the embodiments of the present disclosure.

An embodiment of the present disclosure provides a computer-readable storage medium storing computer programs. The computer programs are configured to, when executed by the processor 511, implement the method described in any one of the embodiments of the present disclosure. In some embodiments, the method may be implemented as the computer programs tangibly contained in the computer-readable storage medium, such as the storage unit 518. In some embodiments, part or all of the computer programs may be loaded and/or mounted on the electronic device 510 via the ROM 512 and/or the communication unit 519. When the computer programs are loaded into the RAM 513 and are executed by the processor 511, one or more steps of the method described above may be performed. Alternatively, in other embodiments, the processor 511 may be configured, in any other suitable manner (such as using firmware), to perform the method described in any one of the embodiments of the present disclosure.

Various embodiments of the systems and technologies described above herein may be achieved in a digital electronic circuit system, an integrated circuit system, a field-programmable gate array (FPGA), an application-specific integrated circuit (ASIC), an application-specific standard product (ASSP), a system on chip (SOC), a complex programmable logic device (CPLD), a computer hardware, a firmware, a software, and/or combinations thereof. These various embodiments may include an embodiment implemented in one or more computer programs. The one or more computer programs are executable and/or interpretable on a programmable system including at least one programmable processor. The programmable processor may be a special-purpose or general-purpose programmable processor and may be configured to receive data and instructions from a storage system, at least one input device and at least one output device and transmit the data and the instructions to the storage system, the at least one input device and the at least one output device.

Computer programs for implementing the methods of the present disclosure may be written in any combination of one or more programming languages. These computer programs may be provided to a general-purpose computer, a special-purpose computer, or a processor of other programmable data processing device to enable the functions/operations specified in a flowchart and/or a block diagram to be implemented when the computer programs are executed by the processor. The computer programs may be executed entirely on a machine, partly on the machine, as a stand-alone software package, partly on the machine and partly on a remote machine, or entirely on the remote machine or server.

In the context of the present disclosure, the computer-readable storage medium may be a tangible medium that may contain or store a computer program available for an instruction execution system, apparatus or device or a computer program used in conjunction with an instruction execution system, apparatus or device. The computer-readable storage medium may include, but is not limited to, an electronic, magnetic, optical, electromagnetic, infrared, or semiconductor system, apparatus or device, or any appropriate combination of the foregoing. Alternatively, the computer-readable storage medium may be a machine-readable signal medium. More specific examples of a machine-readable storage medium may include an electrical connection based on one or more wires, a portable computer diskette, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any appropriate combination of the foregoing.

To provide the interaction with the users, the systems and technologies described here may be implemented on the electronic device. The electronic device has a display device (such as a cathode-ray tube (CRT) or liquid-crystal display (LCD) monitor) for displaying information to the users, and a keyboard and a pointing apparatus (such as a mouse or a trackball) through which the users may provide input to the electronic device. Other kinds of apparatuses may also be used for providing for interaction with the users, for example, feedback provided to the users may be sensory feedback in any form (such as visual feedback, auditory feedback, or haptic feedback), and input from the users may be received in any form (including acoustic input, speech input, or haptic input).

The systems and technologies described here may be implemented in a computing system including a back-end component (such as a data server), or a computing system including a middleware component (such as an application server), or a computing system including a front-end component (such as a client computer having a graphical user interface or a web browser through which the users may interact with the implementations of the systems and technologies described herein), or a computing system including any combination of such back-end component, middleware component, or front-end component. The components of the system may be interconnected by any form or medium of digital data communication (such as a communication network). Examples of the communication network include a local area network (LAN), a wide area network (WAN), a blockchain network and the Internet.

The computing system may include a client and a server. The client and the server are generally remote from each other and typically interact through the communication network. A relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a traditional physical host and a related virtual private server (VPS) service.

According to the above-described embodiments, it can be seen that the display system, the control method for the display system, the electronic device, and the vehicle provided in the present disclosure achieve at least the following beneficial effects. The display system provided in the present disclosure includes the at least one signal loading apparatus and the at least one display screen. The at least one signal loading apparatus is configured to output the specific signal. The display screen includes the control module, the signal recognition module and the touch module. The control module is electrically connected to the signal recognition module and the touch module. The signal recognition module is configured to receive the input signal and detect whether the input signal includes the specific signal. The control module is configured to control the working state of the touch module according to the detection result of the signal recognition module. The display system of the present disclosure includes the at least one signal loading apparatus and the at least one display screen. The medium body may communicate the signal loading apparatus with the display screen so that the specific signal generated by the signal loading apparatus is transmitted to the display screen via the medium body. The signal loading apparatus is configured to output the specific signal. In the display screen, the signal recognition module is configured to receive the input signal and detect whether the input signal includes the specific signal, and the control module is configured to control the working state of the touch module according to the detection result of the signal recognition module. The display system provided in the present disclosure enables the display screen to control the touch module in the display screen to be turned off when it is detected that the input signal includes the specific signal so that the display screen cannot be touched, thereby avoiding the problems such as body inclination and distraction caused by the driver touching the display screen with his hand during the high-speed driving, reducing the safety risk of deviation of the steering wheel, and being beneficial to improving the driving safety of the vehicle.

It is to be understood that various forms of the flows, the reordering step, the adding step or the deleting step shown above may be used. For example, as long as the desired result of the technical solutions of the present disclosure may be achieved, the steps described in the present disclosure may be executed in parallel, sequentially or in different orders, which is not limited herein.

The above specific embodiments should not be construed as limiting the scope of protection of the present disclosure. It is to be understood by those skilled in the art that various modifications, combinations, sub-combinations and substitutions may be made according to design requirements and other factors. Any modification, equivalent replacement, and improvement made within the spirit and principle of the present disclosure should be included within the scope of protection of the present disclosure.

What is claimed is:

1. A display system, comprising:
at least one signal loading apparatus and at least one display screen;
wherein the at least one signal loading apparatus is configured to output a specific signal; and
a display screen of the at least one display screen comprises a control module, a signal recognition module and a touch module, the control module is electrically connected to the signal recognition module and the touch module separately, the signal recognition module is configured to receive an input signal and detect whether the input signal comprises the specific signal, and the control module is configured to control a working state of the touch module according to a detection result of the signal recognition module.

2. The display system of claim 1, wherein the specific signal comprises at least one of a signal having a specific frequency or a signal having a specific waveform.

3. The display system of claim 1, wherein the at least one signal loading apparatus comprises a first signal loading apparatus, and the specific signal comprises a first specific signal output by the first signal loading apparatus;
the at least one display screen comprises a first display screen and a second display screen, the first display screen comprises a first control module, a first signal recognition module and a first touch module, the second display screen comprises a second control module, a second signal recognition module and a second touch module, and in the second display screen, the second signal recognition module is configured to, when detecting that the input signal comprises the first specific signal, output a touch turn-off signal to enable the second control module to control the second touch module to be turned off.

4. The display system of claim 3, wherein in the first display screen, the first control module is configured to control the first touch module to keep an on state.

5. The display system of claim 3, wherein the at least one signal loading apparatus further comprises a second signal loading apparatus, the specific signal further comprises a second specific signal output by the second signal loading apparatus, and the second specific signal is different from the first specific signal.

6. The display system of claim 5, wherein in the second display screen, the second signal recognition module is configured to, when detecting that the input signal comprises the second specific signal, output a touch turn-on signal to enable the second control module to control the second touch module to be turned on.

7. The display system of claim 5, wherein in the first display screen, the first signal recognition module is configured to, when detecting that the input signal comprises the first specific signal or the second specific signal, output a touch turn-on signal to enable the first control module to control the first touch module to be turned on.

8. The display system of claim 5, wherein the second specific signal differs from the first specific signal in at least one of frequency or waveform.

9. The display system of claim 5, wherein the first signal loading apparatus comprises a first seat, a first seat belt, a steering wheel, and a first signal loading module configured to output the first specific signal, and the first signal loading module is mounted on at least one of the first seat, the first seat belt, or the steering wheel; and
wherein the second signal loading apparatus comprises a second seat, a second seat belt, and a second signal loading module configured to output the second specific signal, and the second signal loading module is mounted in at least one of the second seat or the second seat belt.

10. The display system of claim 1, wherein the display screen further comprises a display module and a voice module, and
the control module is electrically connected to the display module and the voice module separately and is configured to control at least one of the display module or the voice module to output a safety reminder signal when controlling the touch module to be turned off.

11. The display system of claim 3, wherein the display system comprises an acquisition module electrically connected to the first signal loading apparatus, and the acquisition module is configured to: acquire first working information of a device electrically connected to the display system; control the first signal loading apparatus to be turned on when detecting that the first working information satisfies a preset turn-on condition; and control the first signal loading apparatus to be turned off when detecting that the first working information does not satisfy the preset turn-on condition.

12. The display system of claim 5, wherein each of the at least one signal loading apparatus comprises a signal generation circuit and a signal sensing circuit which are electrically connected to each other, the signal generation circuit is configured to generate the specific signal, the signal sensing circuit is configured to transmit the specific signal to a medium body, the signal generation circuit of the first signal loading apparatus is configured to generate the first specific signal, and the signal generation circuit of the second signal loading apparatus is configured to generate the second specific signal.

13. The display system of claim 12, wherein the signal sensing circuit comprises signal conduction lines that are distributed in an extended manner, and the signal generation circuit comprises a precision oscillation integrated circuit outputting a plurality of waveforms.

14. A control method for a display system, wherein the display system comprises at least one signal loading apparatus and at least one display screen, the at least one signal loading apparatus is configured to output a specific signal, and a display screen of the at least one display screen comprises a control module, a signal recognition module and a touch module which are electrically connected to the control module; and
wherein a control method for the at least one display screen comprises:
detecting whether an input signal comprises the specific signal; and
controlling, according to a detection result, a working state of the touch module.

15. The control method of claim 14, wherein the at least one signal loading apparatus comprises a first signal loading apparatus, the specific signal comprises a first specific signal output by the first signal loading apparatus, and the at least one display screen comprises a first display screen and a second display screen; and
wherein a control method for the second display screen comprises:
in response to detecting that the input signal comprises the first specific signal, controlling the touch module of the second display screen to be turned off.

16. The control method of claim 15, wherein the at least one signal loading apparatus comprises a second signal loading apparatus, the specific signal comprises a second specific signal output by the second signal loading apparatus, and the second specific signal is different from the first specific signal; and
wherein the control method for the second display screen further comprises:
in response to detecting that the input signal comprises the second specific signal, controlling the touch module of the second display screen to be turned on.

17. An electronic device, comprising:
at least one processor; and
a memory communicatively connected to the at least one processor;
wherein the memory stores a computer program executable by the at least one processor, and the computer program, when executed by the at least one processor, causes the at least one processor to perform a control method comprising:
detecting whether an input signal comprises a specific signal; and
controlling, according to a detection result, a working state of a touch module;
wherein the control method is applied to a display system, the display system comprises at least one signal loading apparatus and at least one display screen, the at least one signal loading apparatus is configured to output the specific signal, and a display screen of the at least one display screen comprises the control module, a signal recognition module and a touch module which are electrically connected to the control module.

18. The electronic device of claim 17, wherein the at least one signal loading apparatus comprises a first signal loading apparatus, the specific signal comprises a first specific signal output by the first signal loading apparatus, and the at least one display screen comprises a first display screen and a second display screen; and
wherein the at least one processor is caused to perform the control method for the second display screen comprising:
in response to detecting that the input signal comprises the first specific signal, controlling the touch module of the second display screen to be turned off.

19. The electronic device of claim 18, wherein the at least one signal loading apparatus comprises a second signal loading apparatus, the specific signal comprises a second specific signal output by the second signal loading apparatus, and the second specific signal is different from the first specific signal; and
wherein the at least one processor is caused to further perform:
in response to detecting that the input signal comprises the second specific signal, controlling the touch module of the second display screen to be turned on.

20. A vehicle comprising the display system of claim 1.
